(19) United States
(12) Patent Application Publication
(10) Pub. No.: US 2010/0017099 A1
(43) Pub. Date: Jan. 21, 2010

(54) SYSTEM AND METHOD FOR PUMP CONTROL

(76) Inventors: Rick Becker, Camarillo, CA (US); Michael C. Cheiky, Thousand Oaks, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 12/503,768

(22) Filed: Jul. 15, 2009

Related U.S. Application Data
(60) Provisional application No. 61/081,329, filed on Jul. 16, 2008.

(51) Int. Cl. F02D 41/30

(52) U.S. Cl. 701/103

(57) ABSTRACT

The present invention is a method and system for controlling a motor attached to a variable displacement pump for providing a supercritical fuel and fuel pressure to a plurality of fuel injectors of a vehicle engine. The system includes: a pump having a motor; a tachometer sensor for measuring a rotational displacement of a motor shaft and for sending a tachometer count value to a memory device; an engine control unit configured to generate a rotational displacement vs. pressure profile of the pump based on the displacement value and pressure value; an accumulator attached to the output of the pump; and a control method that allows for a look ahead and prediction of the pump requirements needed in a future cycle based on current demand to allow for an efficient fuel injection pump.

### RELATED APPLICATIONS

This applications claims the benefit of the priority of U.S. Provisional Patent Application No. 61/081,329 filed on Jul. 16, 2008.

### TECHNICAL FIELD

The present invention relates to a pump, and more particularly, to methods and systems for controlling a fluid pump.

### DESCRIPTION OF THE RELATED ART

Internal combustion engines typically use one or more fuel injectors to inject fuel into a combustion chamber of the engine. The timing of fuel injection can be controlled either electronically or mechanically. In a mechanical system, fuel injectors are generally driven by the crankshaft of the engine via belts, gears or chains. Typically, the fuel injectors are mechanically and synchronously coupled to the crankshaft such that the timing of fuel injection coincides with the intake strokes of the engine's piston. In an electronic system, fuel is generally injected into the engine's intake manifold by regulating an electric solenoid in each fuel injector. The timing for the solenoid is controlled by a computer, which controls the electrical current going into a magnetic coil of the fuel injector.

Generally, a fuel system has to maintain a certain pressure prior to the fuel injector. For a diesel type engine, this pressure can be very high. A pressure of 1,500 psi (100 MPa) or more can be typical in the fuel system of a diesel engine. Fuel pressure is generally provided by a fuel pump that obtains fuel from a fuel reservoir (i.e, gas tank). To help dampen pressure variations in the system, a pressure regulator or accumulator may be connected to the outlet of the fuel pump.

Conventional fuel systems typically have a pump driven by the engine and count injection pulses to calculate feedback to the pump related to the pressure. To vary the flow rate, the rotational displacement of the pump is varied directly as it relates to engine speed. As a result, it is frequently assumed that the relation of the pump output and the motor rotational displacement of the pump is directly linear. However, the relationship of flow rate (pump volume) output vs. the motor rotational displacement is normally not linear. Thus, this assumption can lead to inaccurate pump control.

Some fluid systems such as a fuel injection system may require high pressure fluid at flow rates from 0 to maximum values in a short amount of time. The flow demands of the fluid system may also change abruptly or rapidly over a short amount of time. Conventional high-pressure fluid systems generally have problems with high pressure over spikes when the flow demand is decreased. This increases wear and tear and may cause damage to components of the fluid system.

### BRIEF SUMMARY OF EMBODIMENTS OF THE INVENTION

According to various embodiments of the invention, a pump system having an accurate pump control is provided. The pump system uses a positive displacement pump that may be driven by a brushless direct current motor. Other types of motor can also be employed. The fluid system includes a pump, an accumulator, a pressure sensor, and a tachometer pulse counter.

In one embodiment, the tachometer is coupled to the drive shaft of the pump motor. Particularly, the tachometer may be coupled to the motor in a way that allows the tachometer to measure and record the number of revolutions of the motor and the position of the drive shaft. The tachometer can be one or more position sensor.

The accumulator is used to control the pressure of the pump system. In one embodiment, the pressure sensor is integrated into the accumulator. The pressure sensor can be configured to measure the pressure within the accumulator and to output a signal representative of the pressure value.

In another embodiment, the pump system allows the rotational displacement vs. output pressure relationship to be learned or automatically tuned to the system parameters and accurately predicted by monitoring the pressure and rotational displacement values of the accumulator and the tachometer, respectively. In this way, the pressure of the pump system can be controlled independent of the speed of the engine to which the pump system is attached. The engine is preferably an internal combustion engine having one or more fuel injectors supplied with fuel from the accumulator.

In another embodiment of the present invention, a pump system comprises: a pump having a motor; a tachometer for measuring a rotational displacement value of the motor and for sending the rotational displacement value to a memory device; a pressure sensor for generating a pressure value at an outlet of the pump, wherein the pressure sensor is configured to send the pressure value to the memory device; and a computer configured to generate a rotational displacement-v-pressure profile of the pump based on the rotational displacement and the pressure values.

In an embodiment of the invention, the pump system further includes an accumulator being coupled to an outlet of the pump. In such embodiments, the pressure sensor may be configured to measure a second pressure value at the outlet of the accumulator.

In yet another embodiment, the pump system includes a controller configured to change a rotational displacement of the motor based on the generated rotational displacement-v-pressure profile for a given outlet pressure.

In still another embodiment, the computer is configured to change the motor rotational displacement by: interpolating a set point tachometer count (SPTC) from the set point pressure count based on the generated rotational displacement-v-pressure profile; interpolating a process variable tachometer count (PVCT) based on the generated rotational displacement-v-pressure profile; calculating a control output, wherein the control output is represented by Cₒᵤₜ=(SPTC−PVTC)*P_{GAIN}, wherein P_{GAIN} is a predetermined pressure gain; and controlling the motor rotational displacement based on the calculated control output.

In a further embodiment, the operating drive of the motor is set to 100% when the control output is greater than 100%. In still another embodiment, the operating drive of the motor is set to 0% when the control output is less than or equal to 0%.

In another embodiment of the present invention, a method for controlling a pump is provided. The method includes: measuring a rotational displacement value of a motor of the pump; measuring a pressure value at an outlet of a pressure accumulator coupled to an output of the pump; generating a rotational displacement-pressure profile for the pump based on the measured rotational displacement and pressure values; and controlling an operating characteristic of the motor based on a pressure requirement at the outlet of the pressure accumulator using the generated rotational displacement-pressure profile.

In an additional embodiment, the controlling process further comprises: interpolating a set point tachometer count (SPTC) from the set point pressure count based on the generated rotational displacement-v-pressure profile; interpolating a process variable tachometer count (PVCT) based on the generated rotational displacement-v-pressure profile; calculating a control output, wherein the control output is represented by Cₒᵤₜ=(SPTC−PVTC)*P_{GAIN}, wherein P_{GAIN} is a predetermined pressure gain; and controlling the operating characteristic of the motor based on the control output.

In another embodiment, controlling process further comprises: interpolating a set point tachometer count (SPTC) from the set point pressure count based on the generated rotational displacement-v-pressure profile; interpolating a process variable tachometer count (PVCT) based on the generated rotational displacement-v-pressure profile; and calculating the second control output, wherein the second control output is represented by Cₒᵤₜ=(SPTC−PVTC)×P_{GAIN}+(Expected Change in Flow×Expected Change_{GAIN})+(Flow×Flow_{GAIN}), wherein P_{GAIN} is a predetermined pressure gain, Expected Change in Flow is the expected demand of flow from the ECU less the current measured flow, Expected Change_{GAIN} is a predetermined gain, Flow is a fluid flow rate of the system, Flow_{GAIN} is a predetermined flow gain; and controlling the motor rotational displacement based on the second calculated control output. Flow is represented by: Flow=(Volume Pumped−Volume Stored)/CUT Period. Volume pumped is an amount of fluid volume pumped, volume stored is an amount of fluid volume stored, and control update timer period (CUT Period) is a timing variable used to control the motor of the pump.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 illustrates an example environment in which a pump system can be implemented according to one embodiment of the present invention.

FIG. 2 illustrates an example pump system according to one embodiment of the present invention.

FIG. 3 illustrates a sample rotational displacement vs. pressure profile of a pump system according to an embodiment of the present invention.

FIGS. 4-7 illustrate sample process flow charts according to one or more embodiments of the present invention.

FIG. 8 is an exemplary correction factor table of the present invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward a system and method for controlling a pump based on the rotational displacement vs. output pressure profile of the pump.

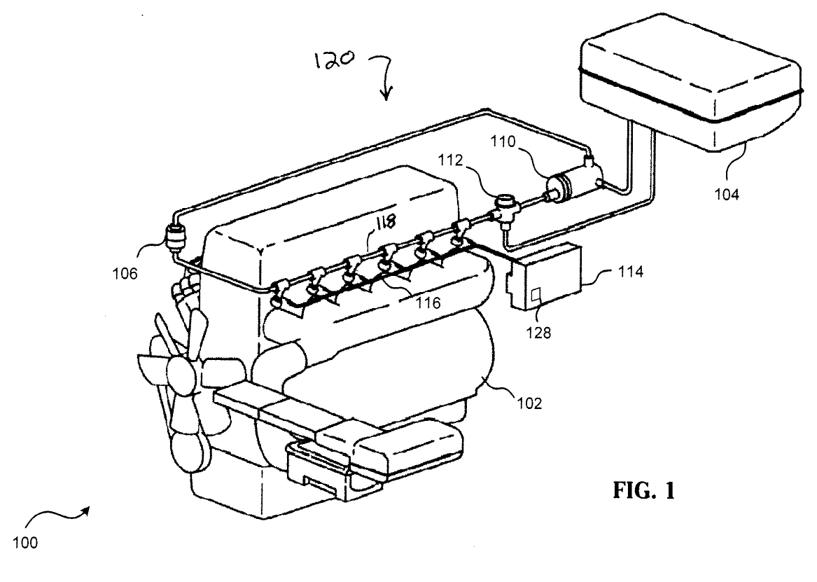

Before describing the invention in detail, it is useful to describe a few example environments with which the invention can be implemented. One such example is that of an engine system in a motor vehicle. FIG. 1 illustrates an engine system 100 that includes an engine 102, a fuel tank 104, a fuel filter 106, a pump 110, a pressure regulator or accumulator 112, a computer 114, and fuel injectors 116. These components, not including engine 102, comprise a fuel system 120. The computer 114 may include an engine control unit (ECU) 128 that receives a throttle input from a pedal sensor (not shown). The ECU outputs an appropriate fuel pressure and displacement volume request to the motor of pump 110. The ECU at the same time outputs an injector actuation request to a plurality of fuel injectors for the engine.

Referring now to FIG. 1, pump 110 draws fuel from fuel tank 104 and forces the fuel to pressure regulator 112, which controls the fuel pressure entering into fuel injectors 116 of engine 102. Pressure regulator 112 helps maintain a certain level of pressure at the input of each fuel injector 116. When the pressure of system exceeds a predetermined maximum pressure, pressure regulator 112 bleeds the excess fuel and pressure back into fuel tank 104. In this way, fuel system 120 and engine 102 are protected from over pressure or pressure spikes. In addition, the pressure regulator 112 can be used to release the pressure from the system when desired by the engine control unit of computer 114. One such instance can be when the vehicle is stopped and idling and a lower pressure is demanded. The opening of the pressure regulator 112 allows for a quicker and more efficient operation of the pump 110 by allowing for an immediate “dump” or release of pressure.

Fuel filter 106 is typically installed between pump 110 and pressure regulator 112. Fuel filter 106 is responsible for filtering particulates and impurities that may exist in the fuel inside of fuel tank 104. In this way, engine 102 is protected from particulates that could cause damage to engine 102.

Fuel system 120 can be implemented on various types of engines such as gasoline and diesel engines. As shown in FIG. 1, fuel injectors 116 of engine 102 are electronically controlled fuel injectors. The fuel injectors can be used in engines using port or direct injection. In the illustrated embodiment, each of the fuel injectors 116 is an electric solenoid valve fuel injector. In one embodiment, the pump 110 supplies the fuel injectors 116 with supercritical fuel in order to improve the power and efficiency of the engine 102. To open the solenoid valve and allow fuel to enter engine 104, computer 114 sends a current to a magnetic armature inside within fuel injector 116. Once the armature is charged, an electric field forms and attracts the solenoid to create a passage into the combustion chamber of engine 102. The timing for current discharge is regulated by computer 114. This can be done using feedback from sensors inside of engine 102. One example of such sensors is the engine's shaft position sensor. By determining the position of the engine crankshaft, computer 114 can calculate the position of the piston and determine the timing for current discharge.

In fuel system 120, pump 110 and pressure regulator 112 together maintain the fuel pressure inside of a common rail 118, which feeds fuel to each of the fuel injectors 116. As mentioned, the solenoid of fuel injector 116 opens whenever an electric current is discharged. The timing of the electric current discharge is based on the position of the piston or crankshaft of engine 102. Thus, to maintain a generally constant pressure inside of common rail 118 when engine 102 is operating at a high speed, the operating rotational displacement or revolution of fuel pump 110 has to also increase to compensate for the pressure lost as a result of fuel and pressure being bled into each of the fuel injectors 116. In further embodiments, such fuel pressure and engine rotational displacement relationship can be maintained in systems that employ mechanical fuel injectors instead of electronic fuel injectors.

From time-to-time, the present invention is described herein in terms of these example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

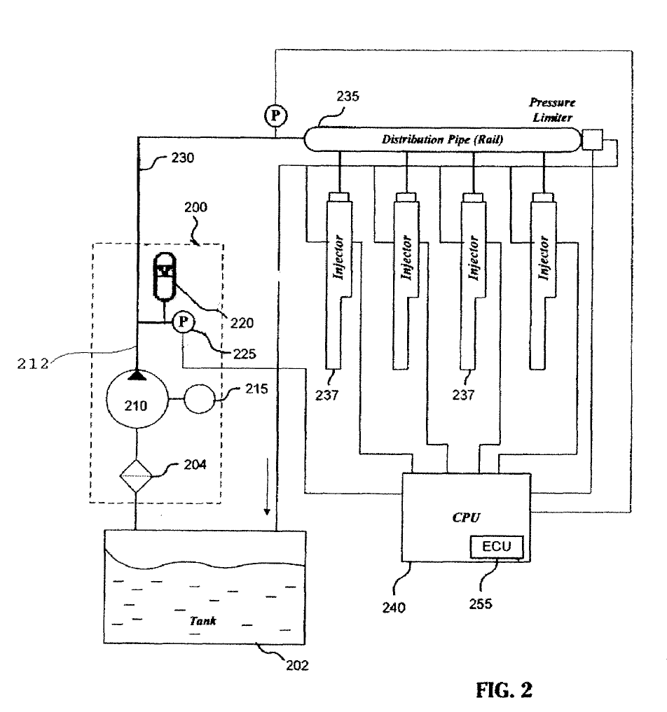

FIG. 2 illustrates a pump system 200 according to one embodiment of the present invention. Pump system 200 includes a fuel tank 202, a fuel filter 204, a fuel pump 210, a tachometer 215, accumulator 220, a pressure sensor 225, a distribution channel 230, and a computer 240 having an electronic control unit 255. On a high level, fuel pump 210 draws fuel through fuel filter 204 and supplies the fuel to an engine (or other device that requires pressurized fluid) via distribution channel 230. In one embodiment, distribution channel 230 is a common rail 235 configured to supply fuel to a plurality of fuel injectors 237. Other types of distribution channel can also be used in place of common rail 235.

In pump system 200, pump 210 can be a positive displacement pump. Pump 210 is preferably a radial piston pump having a high efficiency with minimal to no leakage of fluid out of the piston pumping chambers. The motor attached to pump 210 rotates a shaft that runs the pump. Each rotation of the motor shaft corresponds to a set volume of fluid pumped by the pump pistons. Tachometer 215 can be configured to sense the rotational displacement of the motor shaft as it relates to volume of fluid pumped and sends the rotational displacement data to computer 240. Tachometer 215 can be a hall sensor having 1-3 poles depending on the needs of the user.

Pressure sensor 225 can be configured to monitor the pressure of the fluid at an outlet 212 of pump 210 and send the pressure data to computer 240. For every rotational displacement value or tachometer count of the motor of pump 210 there is a corresponding fluid pressure value at outlet 212. Computer 240 records and tabularizes the pressure and motor rotational displacement data to create a motor rotational displacement vs. pressure profile for pump 210. The rotational displacement and pressure data can be collected using recording means for storing the data into a memory and/or transmitting the data to a remote data storage system. The pressure data may be analog or digital data.

In one embodiment, the motor of pump 210 is a brushless direct current motor. The brushless direct current motor can be best suited for the stop and start type requests that are sent by computer 240. A stepper motor can also be used using 4-8 poles if more discrete control of the motor is needed. Alternatively, a synchronous alternating current motor could be used in situations where a slower responding motor is desired. In this way, accurate control of the pump motor for optimal combustion with the ability to stop and start the pressure of the pump as needed can be achieved. Further, the pump can be started to attain optimal pressure at idle to allow for quick and efficient firing of the injectors when the throttle is actuated after idling.

In pump system 200, accumulator 220 is preferred but not required. As mentioned, accumulator 220 helps dampen pressure variations, particularly small pressure variations within pump system 200. Where pump system 200 incorporates accumulator 220, pressure sensor 225 can be configured to measure the pressure at an outlet of accumulator 220 and to send the measured pressure data to computer 240 or other data storage devices. In one embodiment, pressure sensor 225 can be integrated into accumulator 220. Pressure sensor 225 may comprise a computer module with data collection and transmission capabilities.

With accumulator 220, the rotational displacement vs. pressure profile will be different than a pump system without accumulator 220. Thus, a new rotational displacement vs. pressure profile will have to be produced for a pump system with accumulator 220. As mentioned, for any rotational displacement value of the motor of pump 210 there is a corresponding fluid pressure value at the output of accumulator 220. Computer 240 or pressure module 225 can be configured to record and tabularize the pressure and motor rotational displacement data to create a motor rotational displacement vs. pressure profile for system 200 with accumulator 220.

Once the rotational displacement vs. pressure profile is established for pump system 200, the fluid pressure at the output of accumulator 220 can be accurately controlled by varying the rotational displacement of the pump motor based on the established rotational displacement vs. pressure profile.

In one embodiment, fuel system 200 is connected to common rail 235, which can be connected to a plurality of fuel injectors. The fuel pressure at the output of accumulator 220 may be affected by the presence of the common rail; thus, a new motor rotational displacement vs. pressure profile should be developed for this particular arrangement. A specific rotational displacement vs. pressure profile should be developed in view of what distribution channel 240 is connected to (e.g., a common rail of a diesel engine, a common rail of a gasoline engine, etc.).

In one embodiment, computer 240 may initiate a learning mode or self-tuning mode to develop a rotational displacement vs. pressure profile for pump system 200 upon a request of the user or at a predetermined time such as after a maintenance routine. The self-tuning mode can take place before the engine is started and essentially is the operation of the pump in a closed loop to create a rotational displacement vs. pressure profile for the pump system.

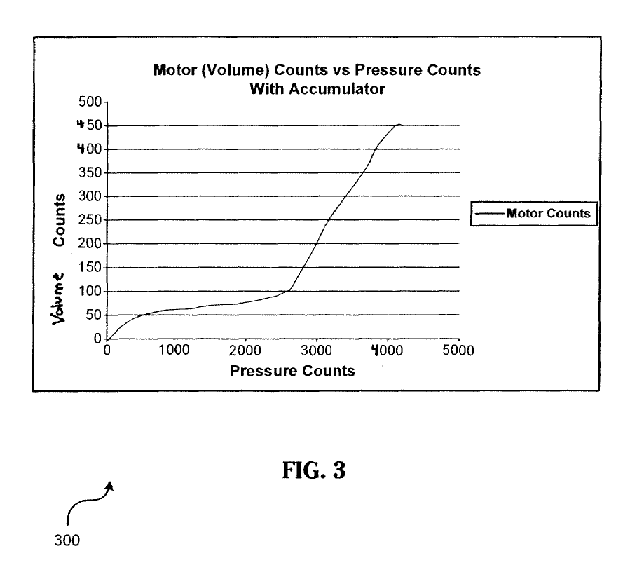

FIG. 3 illustrates a rotational displacement vs. pressure profile 300 of pump system 200 with the use of accumulator 220 according to an embodiment of the present invention. Referring now to FIG. 3, profile 300 has an operating range of between about 100 to 350 motor counts where the pressure is ramped up at a substantially linear level between about 2500 and 3800 pressure counts. The motor count and pressure count data are collected by tachometer 215 and pressure sensor 225, respectively. Rotational displacement-pressure profile 300 can also be obtained via a test run or calibration process or during a self-tuning mode. In one embodiment, rotational displacement-pressure profile 300 can be periodically or continuously updated during the normal operation of pump system 200 so that it self-tunes to create a more accurate profile for use.

In one embodiment, once an initial rotational displacement-pressure profile 300 has been obtained, profile 300 can be periodically or continuously updated during the normal operation of pump system 200. In this way, pump system 200 can be accurately operated at any given pressure requirement over a period of use of pump system 200. For example, wear and tear or other factors may change the efficiency or operational characteristics of pump system 200 over time. However, when the rotational displacement-pressure profile 300 is constantly updated during the normal operation of pump system 200, an accurate output pressure of the pump can still be obtained via the rotational displacement-pressure profile 300, even if pump system 200 has lost or changed its operating efficiency.

As mentioned, profile 300 allows computer 240 to accurately control the rotational displacement of pump 210 for any given pressure requirement. This form of active control allows pump system 200 to be versatile, meaning pump system 200 can be connected to various types of pressurized fluid system such as a gasoline and diesel engines. Each pressurized fluid system can be different and may require pump 210 to operate at substantially different rotational displacements for a given pressure requirement. For example, one system may require a pump to be operating at 100 motor counts for a pressure count of 1000, while another system may require the same pump to be operating at 210 motor counts for the same pressure requirement. Since pump system 200 is configured to learn and to periodically update the rotational displacement-pressure profile of pump 210, pump system 200 can be used with a variety of pressurized fluid systems.

On a high level, the calibration process is done with the following operations: a) set up pump system 200 with fluid demand at zero flow and pressure reading at pressure sensor 225 at zero, with or without the accumulator 220; b) drive pump motor 210 at a low speed and record tachometer counts and the corresponding pressure counts as the pressure builds from zero to a maximum pressure count; c) tabularize the data and generate a rotational displacement vs. pressure profile. In one embodiment, computer 240 is configured to collect data from tachometer 215 and pressure sensor 225 during the normal operation of fuel system 200 to periodically update the rotational displacement-pressure profile of pump system 200 (e.g. profile 300). In this way, the rotational displacement vs. pressure profile can better interpolate a motor count value for any pressure count requirement.

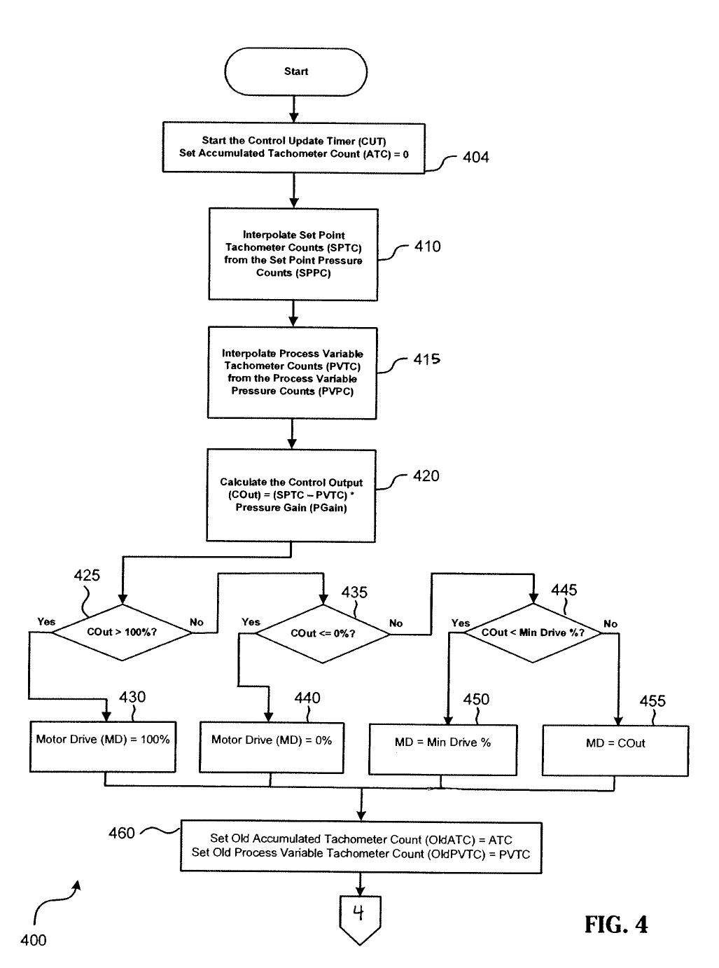

FIG. 4 is a control process 400 for pump system 200 according to one embodiment of the present invention. Referring now to FIG. 4, control process 400 starts at step 404 where the control update timer (CUT) is set to a predetermined time interval and the accumulated tachometer count is set to zero.

In step 410, a set point tachometer count (SPTC) is interpolated from the set point pressure counts (SPPC) using a rotational displacement-pressure profile generated during the calibration/set-up process. In this scenario, step 410 can use rotational displacement-pressure profile 300, depending on the design of pump system 200, to interpolate the set point tachometer count, which is determined by the desired pressure value of the system. In one embodiment, the desired pressure value of the system is determined by the system computer such as computer 240. To simplify the discussion of control process 400, rotational displacement-pressure profile 300 will be used.

In step 415, the process variable tachometer count (PVTC) is interpolated from the process variable pressure counts based on rotational displacement-pressure profile of the pump system. Process variable pressure counts can be thought of as the actual pressure counts at the time the control takes place, meaning at the time where computer 240 takes steps to control the rotational displacement and pressure of pump system 200.

In step 420, the calculated control output (Cₒᵤₜ) is calculated. Cₒᵤₜ is represented by the equation: Cₒᵤₜ=(SPTC−PVTC)*P_{GAIN}. SPTC is the set point tachometer count determined at step 410, whereas PVTC is the process variable tachometer counts determined at step 415. P_{GAIN} is the pressure gain determined by the user or computer 240 during a tuning or calibration process of the system for optimum operation. In one embodiment, the pressure gain value is set at a value such that the chance of overshooting the set point tachometer count (SPTC) is low. At the same time, the pressure gain value should be set to allow for a rapid rise in tachometer counts when needed.

In step 425, it is determined whether Cₒᵤₜ is greater than 100% of the pump's motor capacity, for example, pump 210. If it is determined that Cₒᵤₜ is greater than 100%, then the process moves to step 430 where the motor drive is set at 100%.

If it is determined that Cₒᵤₜ is less than 100%, then the process moves to step 435. In step 435, it is determined whether Cₒᵤₜ is less than or equals to 0%. If the answer is “yes”, the process moves to step 440 where the motor drive or pump 210 is set at 0%.

Step 445 is executed if the answer is “no” at step 435. In step 445, it is determined whether Cₒᵤₜ is less than the pump motor preset minimum %. This is a minimum operating percentage set by the user or by the computer for the motor. The minimum motor or drive % is typically required to overcome friction, mechanical losses, or other power losses that are inherent in the system. In general, the pump motor may not move if the operating power of the motor is less than the minimum drive %.

In step 450, the motor drive is set to the minimum drive % if the answer in step 445 is “yes.” Otherwise, in step 455, the motor drive is set to Cₒᵤₜ.

From any of steps 430, 440, 450, and 455, the process proceeds to step 460 where the previous accumulated tachometer count is set to the current accumulated tachometer count. In the first iteration, this value is zero. Also in step 460, the previous process variable tachometer count is set to the current accumulated tachometer count, which is interpolated at step 415.

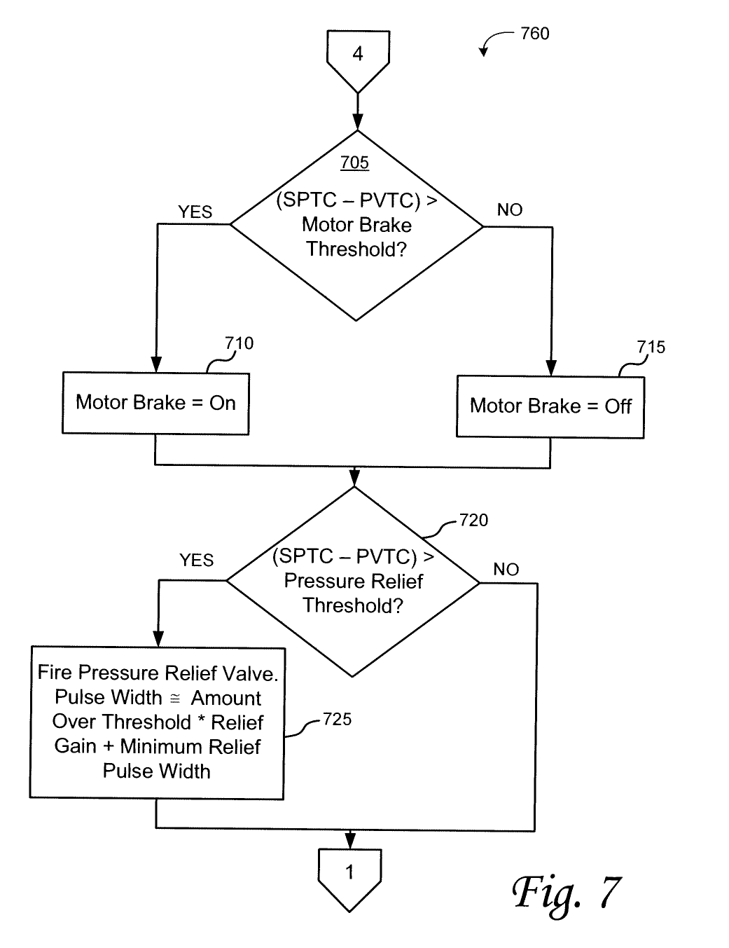

From step 460 and referring to FIG. 7, the process continues to step 705 where the difference between the set point tachometer count (SPTC) and the process variable tachometer counts (PVTC) is compared to see if it is greater than the motor brake threshold.

If it is determined that the difference between the set point tachometer count (SPTC) and the process variable tachometer counts is greater than the motor brake threshold the motor brake is actuated in step 710.

If it is determined that the difference between the set point tachometer count (SPTC) and the process variable tachometer counts is not greater than the motor brake threshold the motor brake is not actuated in step 715.

The process continues from step 710 or 715 to check if the difference between the set point tachometer count (SPTC) and the process variable tachometer counts (PVTC) is compared to see if it is greater than the pressure relief threshold 720.

If it is determined that the difference between the set point tachometer count (SPTC) and the process variable tachometer counts is greater than the pressure relief threshold a pressure relief valve pulse width is fired that is equal to the amount of over threshold*relief gain+minimum relief pulse width in step 725.

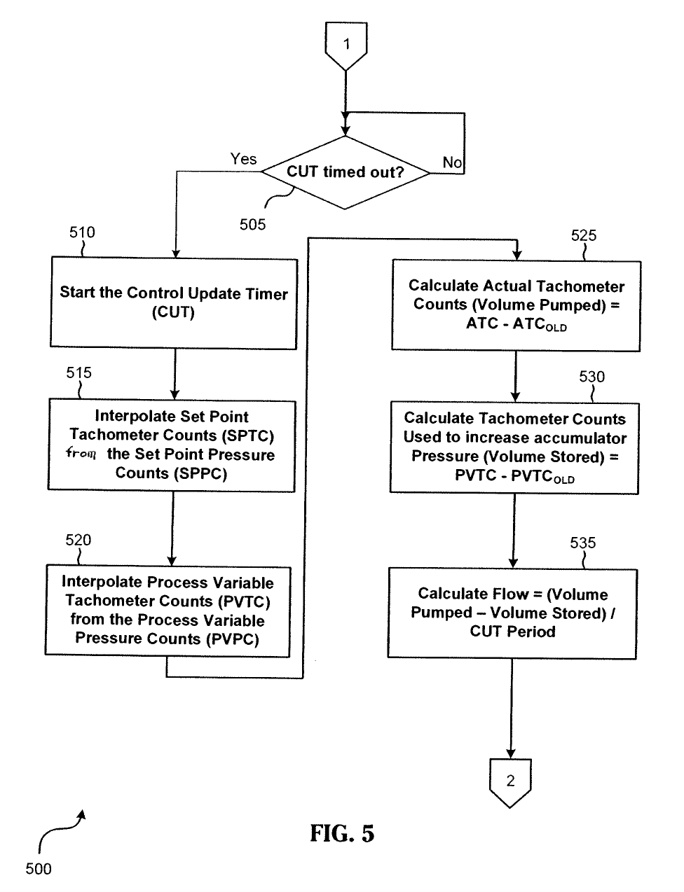

From step 725 or if it is determined that the difference between the set point tachometer count (SPTC) and the process variable tachometer counts is not greater than the pressure relief threshold, the process continues to step 505 as shown in FIG. 5, according to one embodiment of the present invention. Referring now to FIG. 5, process flow 500 starts at step 505 where it is determined whether the control update timer (CUT) is timed. The CUT is a timer that sets a sample period for looking at the current status of the system, and when it times out it is reset. During the time that CUT is running, the system is carrying out the commands provided by the ECU (ECU 128 or 255) SO there are system changes that take place during the CUT that are then measured during the next sample period. If the answer is “no”, a loop is created and step 505 is repeated until the answer is “yes”, which is when step 510 is executed. This starts the 2^{nd} cycle.

Steps 510-535 are sequentially described below; however, the order of execution may or may not be sequential. In step 510, the control update timer is started or restarted. In step 515, the set point tachometer count (SPTC) is interpolated from set point pressure counts using the rotational displacement-pressure profile for the pump system (e.g., profile 300). In step 520, the process variable tachometer counts (PVTC) is interpolated from the process variable pressure counts (PVPC) using the pump system's rotational displacement-pressure profile.

In step 525, the actual current cycle tachometer counts (volume pumped) is calculated. The actual current cycle tachometer counts (ATC) is represented by the following equation: ATC_{current cycle}=ATC_{accumulated}−ATC_{old}. The equation takes how many times the motor has rotated until a predetermined time of a cycle (ATC_{accumulated}) and subtracts from it the ATC from the last sample period (ATC_{old}). This yields the number of tachometer counts for the current sample period so that the current flow rate of the current cycle can be calculated.

In step 530, the tachometer counts used to increase pressure at the output of the pump or the output of the accumulator (volume stored) is calculated. This value, Tachometer counts (TC_{increase}) is represented by TC_{increase}=PVTC_{new}−PVTC_{old}. In step 535, the flow is calculated, which is represented by the following equation:

Flow=(Volume Pumped−Volume Stored)/CUT Period.

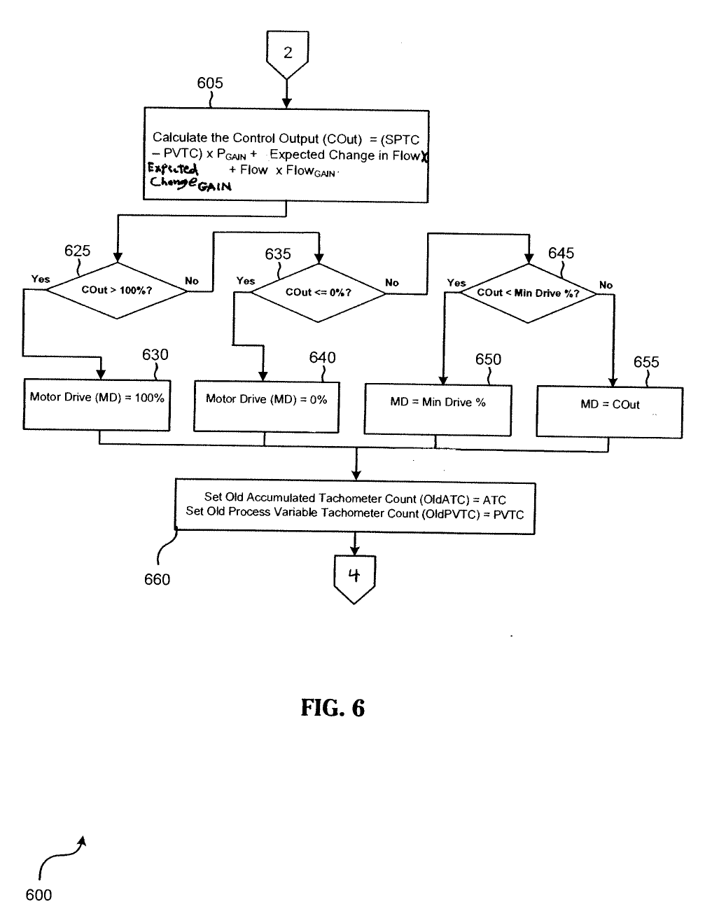

After step 535, the control process continues with process flow 600, as shown in FIG. 6, according to one embodiment of the present invention. Referring now to FIG. 6, process 600 starts at step 605 where the control output is again calculated. However, at this stage, Cₒᵤₜ is represented by the following equation: Cₒᵤₜ=(SPTC−PVTC)×P_{GAIN}+(Expected Change in Flow×Expected Change_{GAIN})+(Flow×Flow_{GAIN}). Expected Change in Flow is the expected demand of flow from the ECU less the current measured flow, and Expected Change_{GAIN} is a predetermined gain. The Cₒᵤₜ formula allows for the prediction or “looking ahead” of the flow requirements of the system in the future. This allows the pump to respond to predicted flow demands so that the pump can have a fast and efficient reaction time to change in flow demands sent by ECU. The computer 240 can be attached to receive a signal from the ECU of the current flow rate that is demanded by the engine. By factoring in the Expected Change in Flow amount, which is equal to the current flow demanded less the current measured flow, the overall system flow rate will essentially stay the same allowing for quicker response times. The Expected Change_{GAIN} is a predetermined value needed to change the flow rate of the system in order to reach a desired flow level. Steps 625-660 are sequentially described below; however, the order of execution may or may not be sequential.

In one embodiment, the flow_{GAIN} is a predetermined flow value needed to change the flow rate of the system in order to reach a desired flow level. This flow gain value is system dependent, meaning different systems will have different system characteristics, thus affecting the flow_{GAIN} value. In pump system 200, flow_{GAIN} can be determined by computer 240.

As mentioned, SPTC is the set point tachometer count determined at step 515, while PVTC is process variable tachometer counts determined at step 520. P_{GAIN} is the pressure gain determined by the user or computer 240 during a tuning or calibration process of the system for optimum operation.

In step 625, it is determined whether Cₒᵤₜ is greater than 100% of the pump's motor capacity, for example, pump 210. If it is determined that Cₒᵤₜ is greater than 100%, then the process moves to step 630 where the motor drive is set at 100%.

If it is determined that Cₒᵤₜ is less than 100%, then the process moves to step 635. In step 635, it is determined whether Cₒᵤₜ is less than or equal to 0%. If the answer is “yes,” the process moves to step 640 where the motor drive or pump 210 is set at 0%.

Step 645 is executed if the answer is no at step 635. In step 645, it is determined whether Cₒᵤₜ is less than the pump motor preset minimum %. This is a minimum operating percentage set by the user or by the computer for the motor. The minimum motor or drive % is typically required to overcome friction, mechanical losses, or other power losses that are inherent in the system. In general, the pump motor may not move if the operating power of the motor is less than the minimum drive %.

In step 650, the motor drive is set to the minimum drive % if the answer in step 645 is “yes.” Otherwise, in step 655, the motor drive is set to Cₒᵤₜ.

From any of steps 630, 640, 650, and 655, the process proceeds to step 660 where the previous accumulated tachometer count is set to the current accumulated tachometer count. Also in step 660, the previous process variable tachometer count is set to the current accumulated tachometer count, which is interpolated at step 515. Once step 660 is completed, the process reverts back to process flow 700 at step 705 This creates a loop between process flows 500 and 600. In this way, the pump (e.g. pump 210) can be adjusted for any changes in demand on the system.

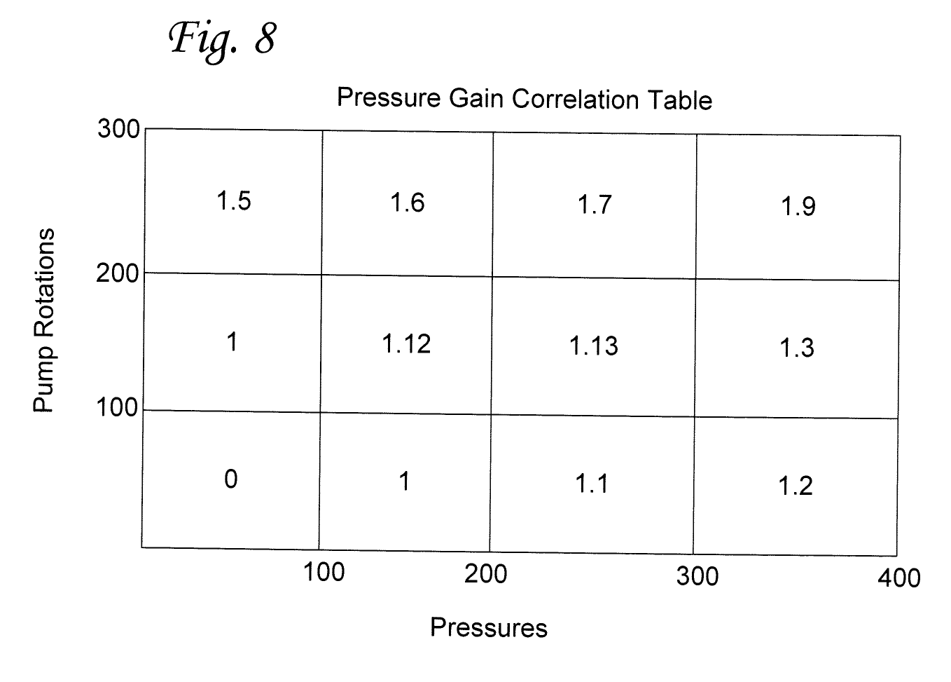

In another embodiment, an additional correction factor table can be used to further improve the accuracy of the pump control. An exemplary correction factor table is shown in FIG. 8. It has been found that the characteristics of the pump system may dynamically change over the pump rotation range as relating to pressure. In order to compensate for such changes a correction factor for the pressure gain, flow gain, and expected demand gain can be provided. FIG. 8 shows an exemplary table showing pump rotations vs. pressure for the pressure gain value that is to be used in the pump control equations. Accordingly, when the pump control program requires the pressure gain value for controlling the pump the given pressure and pump rotations that are required at that time are looked up by the ECU in the correction factor table and used in the calculation of pump control. A similar table can be created for flow gain, and expected demand gain. These correction factor tables can be predetermined through lab testing and then stored in the computer 240 data bank for use during pump control. The use of the correction factor tables allows for more accurate control of the pump.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this section prevails over the definition that is incorporated herein by reference.

The term tool can be used to refer to any apparatus configured to perform a recited function. For example, tools can include a collection of one or more modules and can also be comprised of hardware, software or a combination thereof. Thus, for example, a tool can be a collection of one or more software modules, hardware modules, software/hardware modules or any combination or permutation thereof. As another example, a tool can be a computing device or other appliance on which software runs or in which hardware is implemented.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof, the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A system comprising:
a pump having a motor;
a tachometer for measuring a rotational displacement value of the motor and for sending the rotational displacement value to a memory device;
a pressure sensor for generating a pressure value at an outlet of the pump, the pressure sensor configured to send the pressure value to the memory device;
an accumulator coupled to an outlet of the pump, wherein the pressure sensor is configured to measure a second pressure value at the outlet of the accumulator; and
a computer configured to generate a rotational displacement-v-pressure profile of the pump based on the rotational displacement value and the pressure value.

2. The system of claim 1, further comprising a controller configured to change a rotational displacement of the motor based on the generated rotational displacement-v-pressure profile for a given outlet pressure.

3. The system of claim 1, wherein the computer is configured to change the motor rotational displacement by:
interpolating a set point tachometer count (SPTC) from the set point pressure count based on the generated rotational displacement-v-pressure profile;
interpolating process variable tachometer counts (PVCT) based on the generated rotational displacement-v-pressure profile; and
calculating a control output, wherein the control output is represented by Cₒᵤₜ=(SPTC−PVTC)*P_{GAIN}, wherein P_{GAIN} is a predetermined pressure gain; and
controlling the motor rotational displacement based on the calculated control output.

4. The system of claim 3, wherein the computer is configured to change the motor rotational displacement based on a second control output, wherein the second control output is calculated by:
interpolating a set point tachometer count (SPTC) from the set point pressure count based on the generated rotational displacement-v-pressure profile;
interpolating a process variable tachometer count (PVCT) based on the generated rotational displacement-v-pressure profile; and
calculating the second control output, wherein the second control output is represented by Cₒᵤₜ=(SPTC−PVTC)×P_{GAIN}+Expected Change in Flow×Expected Change_{GAIN}+Flow×Flow_{GAIN}, wherein P_{GAIN} is a predetermined pressure gain, Expected Change in Flow is the feed forward of Flow demand from the ECU less the current measured flow, Flow is a fluid flow rate of the system, and Flow_{GAIN} is a predetermined flow gain; and
controlling the motor rotational displacement based on the second calculated control output.

5. The system of claim 4, wherein Flow is represented by:
Flow=(Volume Pumped−Volume Stored)/CUT Period
wherein volume pumped is an amount of fluid volume pumped, volume stored is an amount of fluid volume stored, and CUT Period is a timing variable used to control the motor of the pump.

6. A method for changing a pump motor rotational displacement, comprising:
providing a pump having a motor;
providing a tachometer for measuring a rotational displacement value of the motor and for sending the rotational displacement value to a memory device;
providing a pressure sensor for generating a pressure value at an outlet of the pump, the pressure sensor configured to send the pressure value to the memory device;
providing an accumulator coupled to an outlet of the pump, wherein the pressure sensor is configured to measure a second pressure value at the outlet of the accumulator;
providing a computer configured to generate a rotational displacement-v-pressure profile of the pump based on the rotational displacement value and the pressure value; and
changing the motor rotational displacement.

7. The method of claim 6, wherein changing the motor rotational displacement comprises:
interpolating a set point tachometer count (SPTC) from the set point pressure count based on the generated rotational displacement-v-pressure profile;
interpolating process variable tachometer counts (PVCT) based on the generated rotational displacement-v-pressure profile; and
calculating a control output, wherein the control output is represented by Cₒᵤₜ=(SPTC−PVTC)*P_{GAIN}, wherein P_{GAIN} is a predetermined pressure gain; and
controlling the motor rotational displacement based on the calculated control output.

8. The method of claim 7, further comprising changing the motor rotational displacement based on a second control output.

9. The method of claim 8, wherein changing the motor rotational displacement based on a second control output comprises:
interpolating a set point tachometer count (SPTC) from the set point pressure count based on the generated rotational displacement-v-pressure profile;
interpolating a process variable tachometer count (PVCT) based on the generated rotational displacement-v-pressure profile; and
calculating the second control output, wherein the second control output is represented by Cₒᵤₜ=(SPTC−PVTC)×P_{GAIN}+Expected Change in Flow×Expected Change_{GAIN}+Flow×Flow_{GAIN}, wherein P_{GAIN} is a predetermined pressure gain, Expected Change in Flow is the feed forward of Flow demand from the ECU less the current measured flow, Flow is a fluid flow rate of the system, and Flow_{GAIN} is a predetermined flow gain; and
controlling the motor rotational displacement based on the second calculated control output.

10. The method of claim 9, wherein Flow is represented by:
Flow=(Volume Pumped−Volume Stored)/CUT Period
wherein volume pumped is an amount of fluid volume pumped, volume stored is an amount of fluid volume stored, and CUT Period is a timing variable used to control the motor of the pump.

11. A system comprising:
a pump having a motor;
a tachometer for measuring a rotational displacement value of the motor and for sending the rotational displacement value to a memory device;
a pressure sensor for generating a pressure value at an outlet of the pump, the pressure sensor configured to send the pressure value to the memory device;
an accumulator coupled to an outlet of the pump, wherein the pressure sensor is configured to measure a second pressure value at the outlet of the accumulator;
a computer configured to generate a rotational displacement-v-pressure profile of the pump based on the rotational displacement value and the pressure value; and
a controller configured to change a rotational displacement of the motor based on the generated rotational displacement-v-pressure profile for a given outlet pressure.

12. The system of claim 1, wherein the computer is configured to change the motor rotational displacement by:
interpolating a set point tachometer count (SPTC) from the set point pressure count based on the generated rotational displacement-v-pressure profile;
interpolating process variable tachometer counts (PVCT) based on the generated rotational displacement-v-pressure profile; and
calculating a control output, wherein the control output is represented by Cₒᵤₜ=(SPTC−PVTC)*P_{GAIN}, wherein P_{GAIN} is a predetermined pressure gain; and
controlling the motor rotational displacement based on the calculated control output.

13. The system of claim 12, wherein the computer is configured to change the motor rotational displacement based on a second control output, wherein the second control output is calculated by:
interpolating a set point tachometer count (SPTC) from the set point pressure count based on the generated rotational displacement-v-pressure profile;
interpolating a process variable tachometer count (PVCT) based on the generated rotational displacement-v-pressure profile; and
calculating the second control output, wherein the second control output is represented by Cₒᵤₜ=(SPTC−PVTC)×P_{GAIN}+Expected Change in Flow×Expected Change_{GAIN}+Flow×Flow_{GAIN}, wherein P_{GAIN} is a predetermined pressure gain, Expected Change in Flow is the feed forward of Flow demand from the ECU less the current measured flow, Flow is a fluid flow rate of the system, and Flow_{GAIN} is a predetermined flow gain; and
controlling the motor rotational displacement based on the second calculated control output.

14. The system of claim 13, wherein Flow is represented by:
Flow=(Volume Pumped−Volume Stored)/CUT Period
wherein volume pumped is an amount of fluid volume pumped, volume stored is an amount of fluid volume stored, and CUT Period is a timing variable used to control the motor of the pump.
